(19) United States
(12) Patent Application Publication
(10) Pub. No.: US 2024/0157880 A1
(43) Pub. Date: May 16, 2024

(54) SHUTTER-TYPE STORAGE BOX FOR VEHICLE

(71) Applicant: TOYODA GOSEI CO., LTD., Kiyosu-shi (JP)

(72) Inventors: Yusei ITO, Kiyosu-shi (JP); Takashi NONOGAWA, Kiyosu-shi (JP)

(21) Appl. No.: 18/490,335

(22) Filed: Oct. 19, 2023

(30) Foreign Application Priority Data
Nov. 10, 2022 (JP) 2022-180353
Feb. 9, 2023 (JP) 2023-018547

(51) Int. Cl. B60R 7/04; B32B 3/08; B32B 5/02; B32B 5/06; B32B 5/26; B32B 27/12; B32B 27/30

(52) U.S. Cl. CPC B60R 7/04; B32B 3/085; B32B 5/026; B32B 5/073; B32B 5/26; B32B 27/12; B32B 27/302; B32B 2307/722; B32B 2435/02

(57) ABSTRACT

A shutter-type storage box for a vehicle includes a box main body including an opening, a shutter configured to open and close the opening, a shutter housing, and two guide grooves. The shutter housing is provided adjacent to the box main body and is configured to house the shutter in a bent state. The guide grooves are located on opposite sides of the shutter in a width direction and guide movement of the shutter. The shutter includes a shutter main body configured to bend, a cushion layer provided on a surface of the shutter main body, and a covering layer provided on a surface of the cushion layer. The cushion layer is a three-dimensional knitted fabric. The covering layer includes a plastic film.

### BACKGROUND

### 1. Field

The present disclosure relates to a shutter-type storage box for a vehicle.

### 2. Description of Related Art

Japanese Laid-Open Patent Publication No. 2018-140662 discloses a shutter-type storage box for a vehicle. In the publication, this storage box is described as an armrest device for a vehicle (hereinafter referred to as the armrest device).

The armrest device of the publication includes fixed members and a sliding door. The fixed members each include a guide rail including a straight portion and a curved portion. The sliding door includes a cushion and pins attached to the cushion. The cushion includes an elastically deformable cushion main body and a covering that is formed separately from the cushion main body and attached to the cushion main body. The cushion is configured to be elastically deformed in a sliding direction of the sliding door. The pins are supported by the guide rails so as to be slidable. The sliding door is thus configured to be slidable along the guide rails in relation to the fixed members.

The cushion main body of a typical shutter-type storage box for a vehicle is made of urethane foam plastic or the like. The covering is made of a stretchable plastic.

In such a shutter-type storage box, a plastic film may be used as the covering. In such a case, printing can be performed on the surface of the film, adding to the design flexibility for a decorative surface.

However, when using a film as the covering, the following issues may arise. During hot conditions like in midsummer, if the shutter is in a bent state and the temperature inside the passenger compartment is relatively high, the stress acting on the bent film tends to remain in the film due to the heat. As a result, unevenness might occur on the decorative surface of the film, leading to a deterioration in appearance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a shutter-type storage box for a vehicle includes a box main body including an opening, a shutter configured to move along an opening surface of the opening to open and close the opening, a shutter housing that is provided adjacent to the box main body and is configured to house the shutter in a bent state, and two guide grooves that are located on opposite sides of the shutter in a width direction and guide movement of the shutter. The shutter includes a shutter main body configured to bend, a cushion layer provided on a surface of the shutter main body, and a covering layer provided on a surface of the cushion layer. The cushion layer is a three-dimensional knitted fabric. The covering layer includes a plastic film.

Other features and aspects will be apparent from the following detailed description, the drawings, and the claims.

### BRIEF DESCRIPTION OF THE DRAWINGS

FIG. 1 is a perspective view of a shutter-type storage box for a vehicle according to one embodiment, illustrating a state in which a shutter closes an opening.

FIG. 2 is a cross-sectional view taken along line 2-2 of FIG. 1.

FIG. 3 is a cross-sectional view taken along line 3-3 of FIG. 2.

FIG. 4 is a perspective view of a shutter forming the shutter-type storage box shown in FIG. 1.

FIG. 5 is a cross-sectional view taken along line 5-5 of FIG. 4.

FIG. 6 is an enlarged cross-sectional view showing a cushion layer and a covering layer, which form the shutter shown in FIG. 4.

FIG. 7 is an enlarged cross-sectional view showing a cushion layer and a covering layer according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

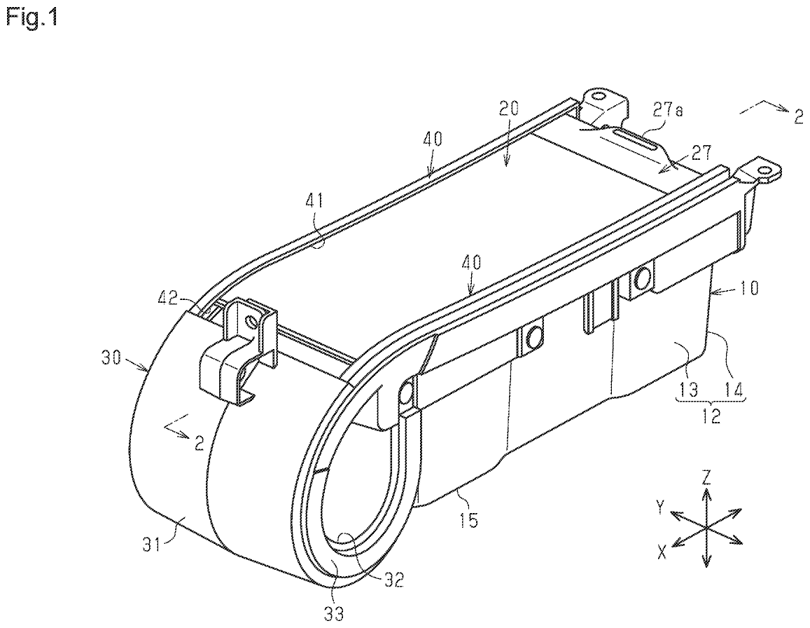

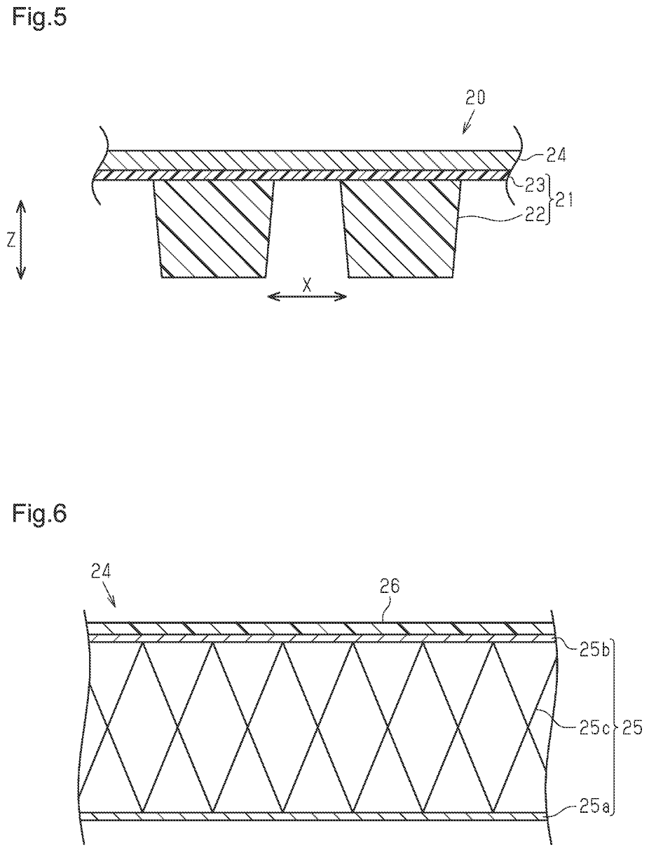

An embodiment will now be described with reference to FIGS. 1 to 6. For the illustrative purposes, some parts of the structures in the drawings may be exaggerated or simplified. Further, the dimensional ratios of portions may be different from the actual dimensional ratios. Hereinafter, the upper side and the lower side in a vertical direction Z are simply referred to as the upper side and the lower side, respectively.

Basic Configuration of Shutter-Type Storage Box

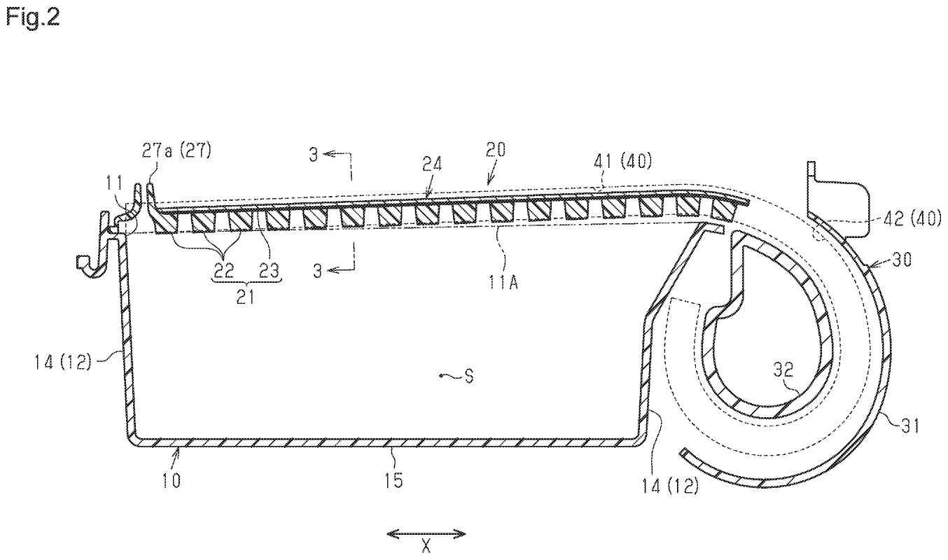

As shown in FIGS. 1 and 2, a shutter-type storage box for a vehicle is provided, for example, in a center console of an automobile. A shutter-type storage box includes a box main body 10, a shutter 20, a shutter housing 30, and two guide grooves 40. The box main body 10 includes an opening 11 that is open upward. The shutter 20 is configured to open and close the opening 11 by moving along an opening surface 11A of the opening 11. The shutter housing 30 is adjacent to the box main body 10 and is configured to accommodate the shutter 20 in a bent state. The two guide grooves 40 are located at opposite sides of the shutter 20 in a width direction Y to guide movement of the shutter 20.

Each component will now be described.

Box Main Body 10

As shown in FIGS. 1 and 2, the box main body 10 includes a peripheral wall 12 and a bottom wall 15. The peripheral wall 12 forms the opening 11. The bottom wall 15 is coupled to the lower edge of the peripheral wall 12 and is opposed to the opening surface 11A of the opening 11.

The opening 11 is rectangular in plan view and has a pair of long sides extending in the front-rear direction of the vehicle and a pair of short sides extending in the vehicle width direction.

The peripheral wall 12 includes two first wall portions 13 (refer to FIG. 1), which form the two long sides of the opening 11, and two second wall portions 14 (refer to FIG. 2), which form the two short sides of the opening 11.

The peripheral wall 12 and the bottom wall 15 define a space S, which accommodates items such as beverage containers and small articles.

Shutter 20

As shown in FIGS. 1 to 4, the shutter 20 includes a shutter main body 21, a flexible sheet member 24, and an operation portion 27 for operating the shutter 20. The shutter 20 has the form of a rectangular plate in a state in which the opening 11 is closed.

In the following description, the long-side direction and the short-side direction of the shutter 20 in a state in which the opening 11 is closed will be referred to as the length direction X and the width direction Y.

Shutter Main Body 21

The shutter main body 21 includes slats 22 and a tape member 23. The slats 22 extend in the width direction Y and are arranged to be separate from each other in the length direction X. The tape member 23 couples the slats 22 together.

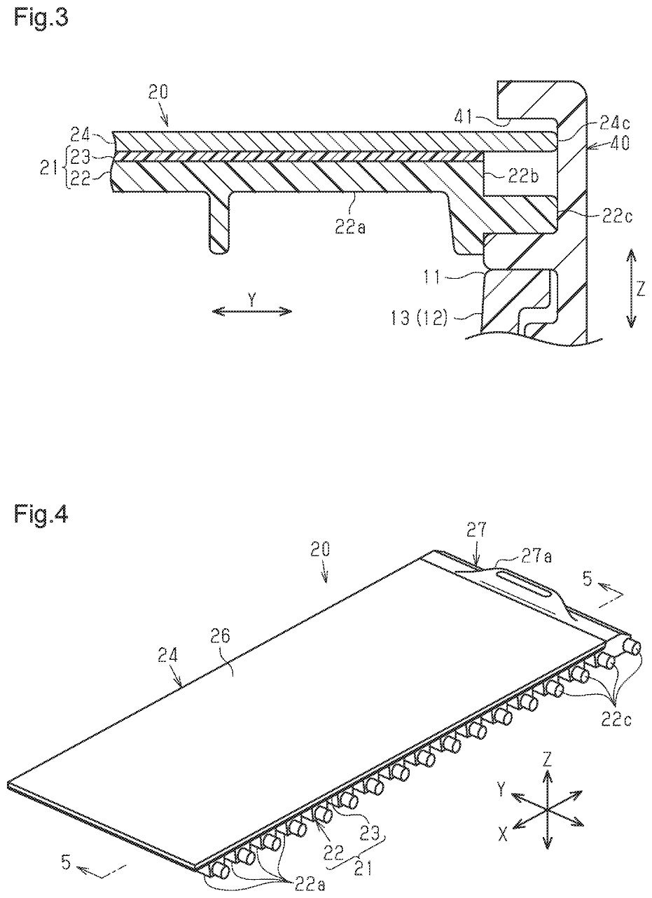

As shown in FIG. 3, the slats 22 are made of a hard plastic. Each slat 22 includes a polygonal post-shaped slat main body 22a, which extends in the width direction Y, and two columnar shaft portions 22c, which respectively protrude outward in the width direction Y from opposite end faces 22b of the slat main body 22a.

The tape member 23 is, for example, a nonwoven fabric tape. The tape member 23 is attached to the upper surfaces of the slats 22.

As shown in FIGS. 2 and 4, the shutter main body 21 is configured such that the slats 22 are coupled together by the tape member 23 so as to be bendable with respect to the length direction X.

Sheet Member 24

As shown in FIG. 6, the sheet member 24 includes a cushion layer 25 provided on the surface of the shutter main body 21 and a covering layer 26 provided on the surface of the cushion layer 25.

The cushion layer 25 is a three-dimensional knitted fabric. The three-dimensional knitted fabric is preferably a double-raschel knitted fabric, which includes a back-side knitted fabric layer 25a bonded to the surface of the shutter main body 21, a top-side knitted fabric layer 25b bonded to the back of the covering layer 26, and connecting yarns 25c, which connect the back-side knitted fabric layer 25a and the top-side knitted fabric layer 25b to each other. In this case, it is preferred that the number of the connecting yarns 25c per specified length in the moving direction of the shutter 20 be less than the number of the connecting yarns 25c per specified length in the width direction Y. That is, the density of the connecting yarns 25c in the moving direction of the shutter 20 is preferably lower than the density of the connecting yarns 25c in the width direction Y. When the shutter 20 is located above the opening 11, the moving direction of the shutter 20 agrees with the length direction X.

The thickness of the cushion layer 25 is preferably in a range of 1 mm to 2 mm.

The cushion layer 25 is bonded to the tape member 23 with adhesive or double-sided tape (neither is shown).

The covering layer 26 is a plastic film. The plastic forming the film is preferably, for example, an acrylonitrile-butadiene-styrene (ABS) copolymer plastic. The decorative surface of the covering layer 26 is a smooth surface.

The covering layer 26 is bonded to the cushion layer 25 with adhesive or double-sided tape (neither is shown).

As shown in FIGS. 3 and 4, the sheet member 24 covers the entire surface of the shutter main body 21.

Operation Portion 27

As shown in FIGS. 1 and 2, the operation portion 27 is arranged at one end of the shutter 20 in the length direction X. The operation portion 27 includes a grip 27a protruding from the upper surface.

Shutter Housing 30

As shown in FIGS. 1 and 2, the shutter housing 30 is adjacent to the box main body 10 in the length direction X. In the present embodiment, the shutter housing 30 is located on the rear side of the box main body 10 with respect to the front-rear direction of the vehicle.

The shutter housing 30 includes a curved outer peripheral wall 31, an inner peripheral wall 32, which is located inward of the outer peripheral wall 31 and has a portion curved along the outer peripheral wall 31, and two side wall portions 33, which connect the ends of the outer peripheral wall 31 and the inner peripheral wall 32 to each other in the width direction Y.

Guide Grooves 40

As shown in FIGS. 1 to 3, the guide grooves 40 are provided on the opposite sides of the box main body 10 and the shutter housing 30 in the width direction Y.

Each guide groove 40 includes a linear portion 41 and a curved portion 42. The linear portion 41 extends straight in the length direction X. The curved portion 42 extends continuously from the linear portion 41 and is curved.

The linear portion 41 is adjacent to the first wall portion 13 at a position above the part of the first wall portion 13 that forms the opening 11 (see FIG. 3).

The curved portion 42 is provided in the corresponding side wall portion 33 of the shutter housing 30.

As shown in FIG. 3, each guide groove 40 receives the shaft portions 22c of the shutter main body 21 and an edge 24c in the width direction Y of the sheet member 24.

The shutter 20 is configured to be movable between a closed position (refer to FIG. 2), at which the opening 11 is closed, and an open position (not shown) by being guided along the guide grooves 40.

Operation of the present embodiment will now be described.

Since the covering layer 26 is a plastic film, the decorative surface can readily be formed through printing.

Also, since the cushion layer 25 is a double-raschel knitted fabric, the stress acting on the covering layer 26 due to bending of the shutter 20 is readily absorbed by changes in the distances and angles between the connecting yarns 25c. Thus, even if the covering layer 26 is heated due to, for example, a high temperature in the passenger compartment, the stress is unlikely to remain in the plastic film forming the covering layer 26. This limits deformation of the covering layer 26 due to residual stress.

The present embodiment has the following advantages.

(1) The above-described operation increases the flexibility in the configuration of the decorative surface of the shutter 20, while improving the heat resistance.

(2) The density of the connecting yarns 25c in the moving direction of the shutter 20 is lower than the density of the connecting yarns 25c in the width direction Y.

With this configuration, the cushion layer 25 is more likely to be bent with respect to the moving direction than with respect to the width direction Y, which allows the shutter 20 to be readily opened and closed. The stress acting on the covering layer 26 due to bending of the shutter 20 is readily absorbed. Further, since the cushion layer 25 is less likely to be deformed in the width direction Y than in the moving direction, the cushion layer 25 is prevented from being excessively soft.

(3) If the thickness of the cushion layer 25 is greater than 2 mm, the tactile impression of the sheet member 24 may be excessively hard. If the thickness of the cushion layer 25 is less than 1 mm, it may be difficult to ensure the absorptive capacity for the stress acting on the covering layer 26 due to bending of the shutter 20.

In this regard, the thickness of the cushion layer 25 is in the range of 1 mm to 2 mm in the present embodiment. This ensures the absorptive capacity for the stress acting on the covering layer 26, while preventing the tactile impression of the sheet member 24 from being excessively hard.

Modifications

The above-described embodiment may be modified as follows. The above-described embodiment and the following modifications can be combined as long as the combined modifications remain technically consistent with each other.

The density of the connecting yarns 25c in the moving direction of the shutter 20 may be set higher than or equal to the density of the connecting yarns 25c in the width direction Y.

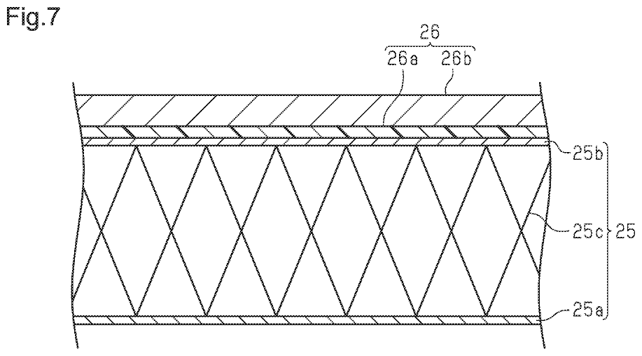

In the above-described embodiment, the covering layer 26 is made of solely a plastic film. However, as shown in FIG. 7, the covering layer 26 may be made of a plastic film 26a and a decorative layer 26b provided on the surface of the film 26a. That is, the plastic film 26a does not have to form a decorative surface of the shutter 20. The decorative layer 26b is preferably, for example, a fabric such as a woven cloth or a print layer. Even in this case, deformation of the film 26a due to the residual stress is limited. This prevents the decorative surface of the decorative layer 26b from being deformed in response to deformation of the film 26a. This configuration increases the flexibility in the configuration of the decorative surface of the shutter 20, while improving the heat resistance.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A shutter-type storage box for a vehicle, the storage box comprising:
a box main body including an opening;
a shutter configured to move along an opening surface of the opening to open and close the opening;
a shutter housing provided adjacent to the box main body, the shutter housing being configured to house the shutter in a bent state; and
two guide grooves located on opposite sides of the shutter in a width direction, the guide grooves guiding movement of the shutter, wherein
the shutter includes:
a shutter main body configured to bend;
a cushion layer provided on a surface of the shutter main body; and
a covering layer provided on a surface of the cushion layer,
the cushion layer is a three-dimensional knitted fabric, and
the covering layer includes a plastic film.

2. The shutter-type storage box for a vehicle according to claim 1, wherein the three-dimensional knitted fabric is a double-raschel knitted fabric that includes:
a back-side knitted fabric layer bonded to the surface of the shutter main body;
a top-side knitted fabric layer bonded to a back of the covering layer; and
connecting yarns that connect the back-side knitted fabric layer and the top-side knitted fabric layer to each other.

3. The shutter-type storage box for a vehicle according to claim 2, wherein a density of the connecting yarns in a moving direction of the shutter is lower than a density of the connecting yarns in the width direction.
